(19) United States
(12) Patent Application Publication
(10) Pub. No.: US 2024/0410377 A1
(43) Pub. Date: Dec. 12, 2024

(54) Charging system of a fuel cell

(71) Applicant: IHI Charging Systems International GmbH, Amt Wachsenburg OT Ichtershausen (DE)

(72) Inventors: Sasa SLAVIC, Heidelberg (DE); Dietmar FILSINGER, Wiesloch (DE)

(73) Assignee: IHI Charging Systems International GmbH, Amt Wachsenburg OT Ichtershausen (DE)

(21) Appl. No.: 18/697,926

(22) PCT Filed: Oct. 11, 2022
(86) PCT No.: PCT/DE2022/100750

§ 371 Date: Apr. 2, 2024

(30) Foreign Application Priority Data
Oct. 21, 2021 (DE) 10 2021 127 332.3

(51) Int. Cl. F04D 17/10; F04D 25/06; H01M 8/04014

(52) U.S. Cl. CPC F04D 17/10; F04D 25/06; H01M 8/04014; H01M 2220/20

(57) ABSTRACT

A charging system of a fuel cell includes a housing for receiving a rotatable compression wheel and a rotatable expansion wheel. A compression section of the housing receives the compression wheel and an expansion section of the housing receives the expansion wheel. The compression section and the expansion section effect wall heat exchange of compression gases flowing in the compression section and expansion gases flowing in the expansion section. The compression wheel and the expansion wheel are a single-piece system wheel which has a shaft. A housing wall separating the compression section and the expansion section has a seal in the form of a labyrinth seal. The labyrinth seal is formed between the compression wheel and the housing wall. The expansion wheel has a smaller diameter than the compression wheel. The system wheel is liquid-repellent. A hub surface of the system wheel facing the electric motor has a projection.

### CROSS-REFERENCE TO RELATED APPLICATION

This application is a national stage application, filed under 35 U.S.C. § 371, of International Patent Application PCT/DE2022/100750, filed on Oct. 11, 2022, which claims the benefit of German Patent Application DE 10 2021 127 332.3, filed on Oct. 21, 2021.

### TECHNICAL FIELD

The disclosure relates to a charging system of a fuel cell.

### BACKGROUND

Drive systems of, in particular, motor vehicles increasingly comprise fuel cells as drive assemblies. Oxygen in the form of atmospheric oxygen is to be supplied to the fuel cell during its operation. A charging system which has already proven successful in supplying air to and increasing the power of an internal combustion engine and which is known, an exhaust gas turbocharger, is suitable for this purpose.

However, by reason of the substantially lower temperatures of an exhaust gas exiting the fuel cell and which in this context is referred to as an expansion gas because it acts upon an expansion wheel of the charging system and does not have a composition according to the typical known exhaust gas, it may be necessary to provide assistance to the charging system which has a rotatably arranged compression wheel and has the likewise rotatably arranged expansion wheel which is connected to the compression wheel for conjoint rotation therewith. The assistance could take the form of energy supply with the aid of an additional drive, e.g. an electric motor, or with the aid of thermal energy.

### SUMMARY

The present disclosure provides a charging system of a fuel cell which is designed to operate efficiently.

The disclosure relates to a charging system of a fuel cell, comprising a housing for receiving a rotatable compression wheel and a rotatable expansion wheel, wherein the housing comprises a compression section and an expansion section, wherein the compression section is designed to receive the compression wheel and the expansion section is designed to receive the expansion wheel. In accordance with the invention, the compression section and the expansion section are designed to effect wall heat exchange of compression gases flowing in the compression section and expansion gases flowing in the expansion section. The compression wheel and the expansion wheel are designed in the form of a single-piece system wheel which has a shaft. A housing wall separating the compression section and the expansion section has a seal in the form of a labyrinth seal. The labyrinth seal is formed between the compression wheel and the housing wall, wherein the expansion wheel has a smaller diameter than the compression wheel. The system wheel is liquid-repellent, wherein a hub surface of the system wheel facing the electric motor has a projection.

That is to say in other words that the two sections, through which their respective gas flows, are designed such that the expansion gas can cool the compression gas and the compression gas can heat the expansion gas. For the purpose of efficient operation, it is easily possible in this manner to dispense e.g. with a so-called charging air cooler, a cooler for reducing a temperature of the compression gas after compression thereof, or said cooler can be reduced at least in terms of its dimensioning. This can be achieved e.g. by adjoining the compression section to the expansion section in such a way that the two sections have a contact which enables wall heat exchange. Furthermore, additional energy is supplied to the expansion gas and can be converted in the expansion section.

The compression wheel and the expansion wheel are designed in the form of a single-piece system wheel which has a shaft. The advantage of the charging system in accordance with the invention can be seen in the fact that with the aid of the single-piece design of the compression wheel and of the expansion wheel a charging system can be provided which is substantially more reduced in its axial extent than has hitherto been known. Furthermore, components of the charging system, such as e.g. the shaft or the housing, can be produced at reduced cost. A further advantage can be seen in the fact that a possible leakage of hydrogen or lubricant with the expansion gas can be directed away from the charging system. Lubricant can thus also be prevented from penetrating into the fuel cell.

In order to avoid a reduction in the power of the charging system or at least to reduce a power loss of the charging system by reason of the single-piece system wheel which requires preferential sealing of the compression section with respect to the expansion section, a housing wall which separates the compression section and the expansion section has a seal in the form of a labyrinth seal. Labyrinth seals, also referred to as contact-free shaft seals, are characterised by virtue of the fact that parts which are movable relative to one another have sealing of their spaces remote from the seal.

In particular, the labyrinth seal is formed between the compression wheel and the housing wall, and a gap formed between the compression wheel and the housing wall can be prolonged with the aid of the labyrinth seal and a flow resistance in the gap can be substantially increased. Therefore, fluidic sealing of the compression section and the expansion section is produced.

In one embodiment of the charging system in accordance with the invention, the expansion section is arranged at least partially surrounding the compression section. Wall heat exchange can be achieved in this manner because between the expansion gas and the compression gas only a wall is formed, via which the heat of the gases can be channeled.

At this point, it should be mentioned that the wall heat exchange is a heat transfer from the compression gas to the expansion gas via a wall located therebetween and vice versa.

The system wheel can be produced from two different materials, i.e. in other words the compression wheel is produced from the first material and the expansion wheel is produced from a second material which is different from the first material. This involves a typically cost-intensive joining method. However, since the temperatures of the gases, the compression gas and the expansion gas, are not temperatures as are known from internal combustion engine construction and the exhaust gas temperatures thereof, the expansion wheel is produced in a cost-effective manner from a second material which corresponds to the first material. That is to say in other words that the system wheel is produced from one single material which, however, can also be a composite material and/or an alloy or the like. The compression wheel is produced from a first material.

Preferably, in order to provide additional sealing the system wheel is designed to be liquid-repellent. That is to say in other words that the system wheel is designed to repel liquids and/or is protected against damage caused by the impact of water droplets. This can be achieved by corresponding shaping of the system wheel or by coating and/or by e.g. hardening the system wheel, in particular the expansion wheel.

In order to repel liquid, a hub surface of the system wheel facing towards the electric motor is designed to be liquid-repellent for this purpose. That is to say in other words that this hub surface can be coated e.g. in a liquid-repellent manner. Preferably, however, it is designed to be liquid-repellent with the aid of its geometric shape. It could be concave e.g. in the direction of the motor housing. In accordance with the invention, the hub surface has a projection, in particular on an outer circumference of the hub surface. Therefore, it is possible in a particularly effective manner to move the liquid, which is conveyed in the direction of the expansion wheel by reason of the centrifugal force, in the direction of an outlet of the expansion section.

In a further embodiment of the charging system in accordance with the invention, the expansion section is arranged at least partially axially next to the compression section, wherein the two sections have a common housing wall. This arrangement of the housing wall is provided preferably in the region of the system wheel which has the compression wheel and the expansion wheel quasi wheel back to wheel back, thus arranged axially next to one another, so that the compression wheel can be advanced into its compression channel and the expansion wheel can be supplied from its expansion channel. Therefore, heat transfer can be achieved in a particularly simple manner.

In a further embodiment, the shaft can be driven with the aid of an electric motor. Expressed in other words, the two wheels are driven or at least assisted with the aid of an electric motor, whereby the charging system power can be increased substantially.

In an advantageous manner, the electric motor is surrounded by a motor housing which is designed to mount the shaft. That is to say in other words that a rotatable mounting arrangement of the shaft can be effected with the aid of the motor housing. Therefore, it is easily possible to achieve secure mounting of the shaft because, irrespective of a design of the mounting arrangement, the mounting arrangement can be spaced apart from the system wheel and thus spaced apart from the expansion gas and can at least be protected therefrom to the greatest possible extent.

In a further embodiment of the charging system in accordance with the invention, the motor housing is designed at least partially as a single piece with the housing. In particular, the motor housing is formed as a single piece with at least a part of the expansion section, thus making it possible to achieve cost-effective production and/or preferential air cooling of the electric motor.

In a further embodiment of the charging system in accordance with the invention, the shaft is a built-up shaft. That is to say in other words that the shaft is formed from at least two parts which are joined together. They can be connected together e.g. in an integrally bonded manner and/or in a force-fitting and/or form-fitting manner. The advantage can be seen in the fact that, in dependence upon a design of the electric motor, a stator or a rotor of the electric motor can be received in a section of the shaft.

Preferably, the shaft is designed to receive the rotor of the electric motor and is connected thereto in particular for conjoint rotation therewith. Likewise, a connection to the rotor for conjoint rotation therewith can also be configured depending upon requirement. With the aid of the built-up shaft, the rotor can be easily received in a secure manner in a cavity of the shaft.

The shaft is advantageously mounted with the aid of a radial bearing which is a plain bearing or a rolling bearing or an air bearing. It is possible to combine the types of bearing. That is to say in other words that the shaft can be mounted with a radial bearing e.g. in the form of a plain bearing and with a radial bearing e.g. in the form of a rolling bearing. Or a radial bearing pairing can be designed in the form of an air bearing-rolling bearing pairing. Different combinations are feasible.

Furthermore, the shaft advantageously has an axial bearing which is a plain bearing or a rolling bearing or an air bearing. Typically, it is necessary to provide only one axial bearing so that a pairing of different types of bearing is not necessary. However, if more than one axial bearing has to be provided, e.g. if two mutually separate shaft pieces are present, different types of bearings can also be paired in this case.

It is mentioned at this juncture that an axial bearing is redundant when a rolling bearing is used. In order to reduce costs, it is therefore advantageous to effect so-called hybridisation of the types of bearing, in particular to provide an air bearing in the region downstream of the system wheel and to arrange a rolling bearing in the region remote from the system wheel. If sealing means are additionally also provided, then a possible ingress of lubricant into the compression section of the housing with the system wheel, which has the compression wheel and the expansion wheel formed as a single piece, is eliminated or at least reduced to the greatest possible extent.

A further sealing means which is arranged surrounding the shaft and serves to provide sealing between the housing and the motor housing, in particular the electric motor, is arranged on a conical section of the shaft and/or on a conically formed sleeve surrounding the shaft. The further sealing means is preferably designed in the form of a labyrinth seal. The advantage is that the conical design of the section of the shaft or sleeve allows liquids such as lubricant, water or grease to penetrate into the further sealing means, particularly when the shaft is stationary, i.e. when the shaft is not rotating, or at very low rotational speeds of the shaft. With the aid of the conical design of the shaft and/or the sleeve which is characterised in particular by the fact that a largest cone diameter of the conical design is arranged facing towards the expansion section and a smallest cone diameter of the conical design is arranged facing towards the motor housing, the liquid which has penetrated is conveyed in the direction of the expansion wheel and removed from the further seal by reason of the centrifugal force during start-up or when the rotational speed is increasing. The cone diameter can be a shaft diameter of the shaft and/or a sleeve diameter of the sleeve.

In order to prevent damage to the system wheel caused by water droplets which can impact on the system wheel with a specific impulse and therefore with a specific force, a correspondingly wear-resistant and/or hard coating can be applied to the system wheel, or e.g. the system wheel can be fully or partially hardened. Therefore, it is formed to be liquid-resistant.

It is mentioned at this juncture that, if e.g. the system wheel has the compression wheel arranged between the motor housing and the expansion wheel, the above explanation relating to the repelling of liquid naturally applies to the compression wheel.

In a further embodiment of the charging system in accordance with the invention, a flow cross-section-changing device is formed upstream of the expansion wheel in the expansion section. This can be designed in the form of a known guide device of an exhaust gas turbocharger, e.g. a so-called VGS, VTG or an axial slide valve.

Further advantages, features and details of the invention will be apparent from the following description of preferred exemplified embodiments and with reference to the drawing. The features and combinations of features mentioned earlier in the description and the features and combinations of features mentioned hereinunder in the description of the figures and/or illustrated in the figures alone can be employed not only in the combination stated in each case but also in other combinations or on their own.

### BRIEF DESCRIPTION OF THE DRAWINGS

FIG. 1 shows a longitudinal sectional view of a charging system having an electric motor in accordance with the prior art which can be used for use for a fuel cell,

FIG. 2 shows a longitudinal sectional view of an inventive charging system of a fuel cell in a first exemplified embodiment,

FIG. 3 shows a longitudinal sectional detail of the inventive charging system of a fuel cell in a second exemplified embodiment,

FIG. 4 shows a longitudinal sectional view of the inventive charging system of a fuel cell in a third exemplified embodiment,

FIG. 5 shows a longitudinal sectional view of the inventive charging system of a fuel cell in a fourth exemplified embodiment,

FIG. 6 shows a longitudinal sectional view of the inventive charging system of a fuel cell in a fifth exemplified embodiment,

FIG. 7 shows a longitudinal sectional detail of the inventive charging system of a fuel cell in a sixth exemplified embodiment,

FIG. 8 shows a detailed view of the inventive charging system shown in FIG. 7,

FIG. 9 shows a longitudinal sectional detail of the inventive charging system of a fuel cell in a seventh exemplified embodiment,

FIG. 10 shows a longitudinal sectional detail of the inventive charging system of a fuel cell in an eighth exemplified embodiment,

FIG. 11 shows a longitudinal sectional view of the inventive charging system of a fuel cell in a ninth exemplified embodiment,

FIG. 12 shows a longitudinal sectional detail of the inventive charging system of a fuel cell in a tenth exemplified embodiment,

FIG. 13 shows a longitudinal sectional detail of the inventive charging system of a fuel cell in an eleventh exemplified embodiment,

FIG. 14 shows a longitudinal sectional detail of the inventive charging system of a fuel cell in a twelfth exemplified embodiment, and

FIG. 15 shows a longitudinal sectional detail of the inventive charging system of a fuel cell in a thirteenth exemplified embodiment.

### DETAILED DESCRIPTION

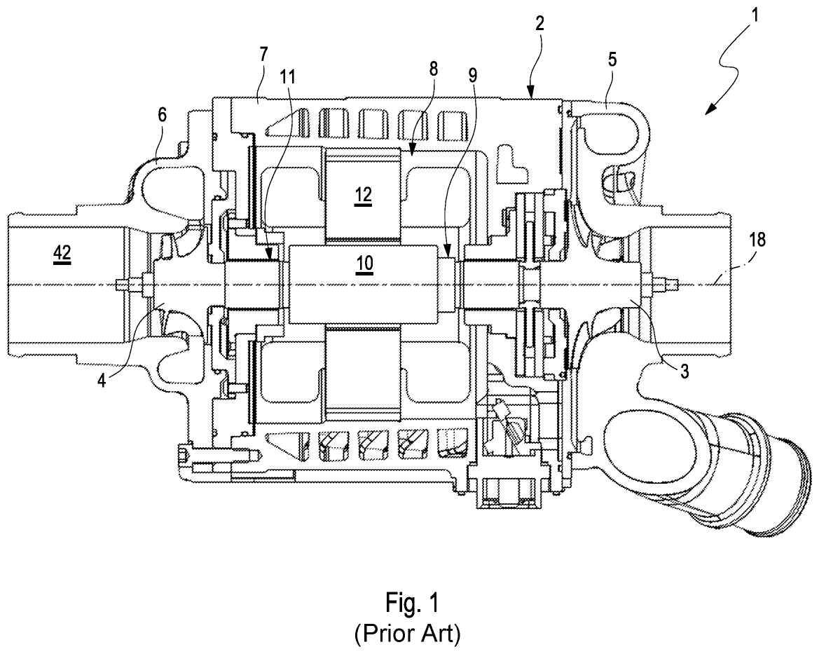

A charging system 1 in accordance with the prior art which is suitable for use for delivering air to a fuel cell is designed as shown in FIG. 1. The charging system 1 has a housing 2 for rotatably receiving a compression wheel 3 and an expansion wheel 4, wherein the housing 2 comprises a compression section 5 and an expansion section 6. The compression section 5 is designed to receive the compression wheel 3 and the expansion section 6 is designed to receive the expansion wheel 4. Arranged between the compression section 5 and the expansion section 6 is a motor housing 7 which is designed to receive an electric motor 8 and for rotatably mounting the compression wheel 3 and the expansion wheel 4. The electric motor 8 can be embedded or coated with the aid of sintering, fusing, casting or injection-moulding. Therefore, a solid closed structure of the electric motor 8 is formed which can be surrounded by a cooling medium.

The compression wheel 3 is connected with the aid of a compression wheel shaft 9 to a rotor 10 of the electric motor 8 which has a stator 12 surrounding the rotor 10. Likewise, the expansion wheel 4 is connected to the rotor 10 with the aid of an expansion wheel shaft 11. Expansion gas from the fuel cell can be applied to the expansion wheel 4 so that it performs a rotating movement which is transmitted via the rotor 10 to the compression wheel 3. Likewise, the rotor 10 is designed to produce and/or assist the rotating movement of the expansion wheel 4 and the compression wheel 5.

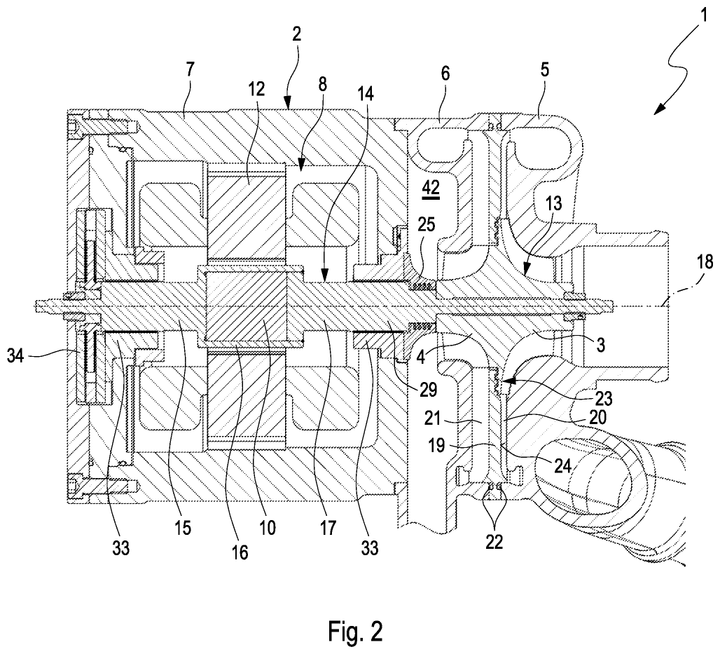

FIG. 2 illustrates an inventive charging system 1 of a fuel cell according to a first exemplified embodiment. The charging system 1 in accordance with the invention is characterised in particular by a system wheel 13 which has the compression wheel 3 and the expansion wheel 4 formed as a single piece. The compression wheel 3 is produced from a first material which corresponds to a second material, from which the expansion wheel 4 is produced. Likewise, it could also be two different materials, wherein cost-effective production of the system wheel 13 can be achieved with the aid of a single material which is composed of different material components.

The system wheel 13 can be driven with the aid of a built-up shaft 14. In this context, a built-up shaft 14 is to be understood to be in particular a two-part shaft which is designed to receive the rotor 10. The shaft 14 is rotatably mounted in the motor housing 7. In a first shaft section 15 of the shaft 14, of which the end section 16 facing towards the system wheel 13 is hollow-cylindrical, the rotor 10 is connected to the first shaft section 15 in a non-twisting manner. A second shaft section 17 of the shaft 14 which is configured for conjoint rotation with the system wheel 13 is received, at its shaft end arranged facing towards the first shaft section 15, likewise in the end section 16 and is connected in an integrally bonded manner thereto. The illustrated embodiment of the built-up shaft 14 is merely one way of integrating the rotor 10 into the shaft 14. Other embodiments, e.g. in which the first shaft section 15 has the hollow-cylindrical end section and/or a force-fitting and form-fitting connection of the two shaft sections 15, 17 are likewise possible.

The housing 2 of the inventive charging system 1 of the first exemplified embodiment has the compression section 5 and the expansion section 6 arranged completely next to one another in the axial direction along a longitudinal axis 18 of the charging system 1, wherein a common housing wall 19 fluidically separates a compression channel 20 of the compression section 5, formed downstream of the compression wheel 3, and an expansion channel 21 of the expansion section 6, formed upstream of the expansion wheel 4, from one another. The housing wall 19 is arranged for producing a pressure-tight housing 2 between the compression section 5 and the expansion section 6 with the aid of sealing means 22.

In order to produce a compression section 5 which is substantially sealed with respect to the expansion section 6 and vice versa, a seal 23 is configured in the form of a labyrinth seal between these two sections 5, 6, wherein the labyrinth seal 23 is advantageously produced between the compression wheel 3 and a wall surface 24 of the housing wall 19 facing towards the compression wheel 3.

In order to prevent lubricant transfer from the motor housing 7 into the expansion section 6 and possibly into the compression section 5, and/or to prevent expansion gas transfer into the motor housing 7, a further sealing means 25 which is produced preferably in the form of a labyrinth seal is arranged between the motor housing 7 and the expansion wheel 4, surrounding the second shaft section 17.

The compression section 5 and the expansion section 6 are designed to effect wall heat exchange of compression gases flowing in the compression section 5 and expansion gases flowing in the expansion section 6. Wall heat exchange between the compression gas and the expansion gas can be effected via the housing wall 19.

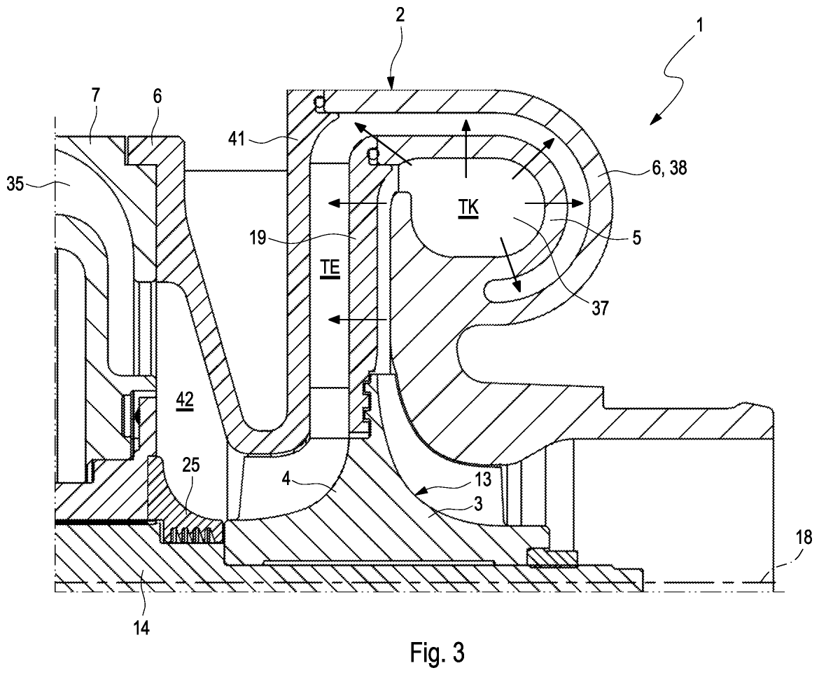

The charging system 1 in accordance with the invention is illustrated in FIG. 3 in a longitudinal sectional detail in a second exemplified embodiment. The compression section 5 and the expansion section 6 are designed to effect heat exchange of compression gases flowing in the compression section 5 and expansion gases flowing in the expansion section 6. It should be emphasised at this juncture that this is not gas exchange between the two sections 5, 6 but instead is heat exchange of the gases via closed walls of the sections 5, 6, i.e. wall heat transfers.

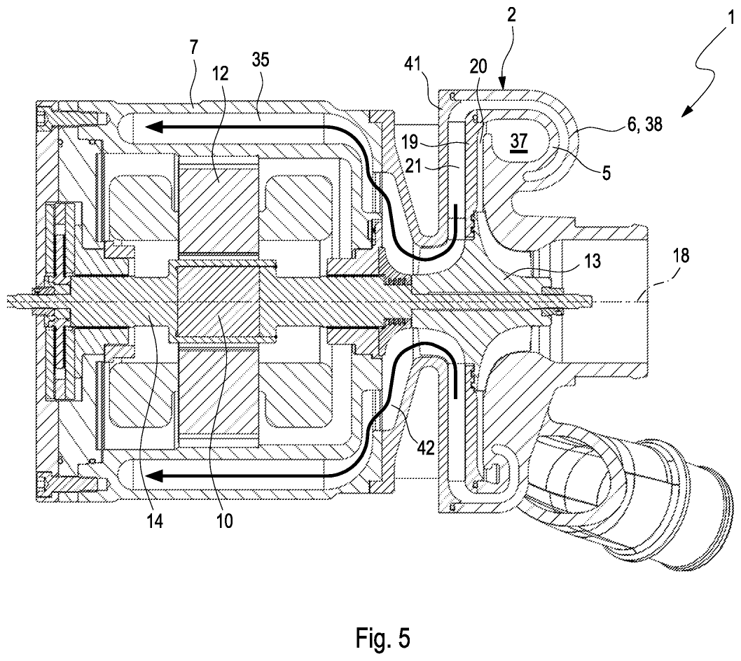

The expansion section 6 is designed at least partially surrounding the compression section 5, in particular in the region of a spiral 37 of the compression section 5. For improved mounting of the housing 2, the compression section 5 and a first expansion section part 38 designed surrounding the compression section 5 are produced as a single piece. The advantage can be seen in the fact that the compressed compression gas which has a compression gas temperature TK having a value of over 200° C. heats the expansion gas, which has an expansion gas temperature TE of ca. 90° C., so that a thermodynamic gradient, which determines the power of the charging system 1, can be increased at the expansion wheel 4 and vice versa because the colder expansion gas cools the warmer compression gas and air cooling of the compression gas can thus be omitted. Downstream of the expansion wheel 4, the expansion gas has an expansion gas temperature TE having a value of ca. 20° C. and can be used for cooling the motor housing 7, wherein the cooling jacket 35 is connected to the expansion section 6 such that a flow can pass therethrough, as illustrated in FIG. 5, an illustration of a fourth exemplified embodiment of the charging system 1 in accordance with the invention. Therefore, it is possible to completely dispense with water cooling of the motor housing 7 because, in particular, extremely small water droplets absorb and evaporate heat of the motor housing 7. The expansion gas which is channeled via the cooling jacket 35 is discharged to the environment via a housing outlet, not illustrated in greater detail. The bearings 33, 34 are designed in the form of air bearings.

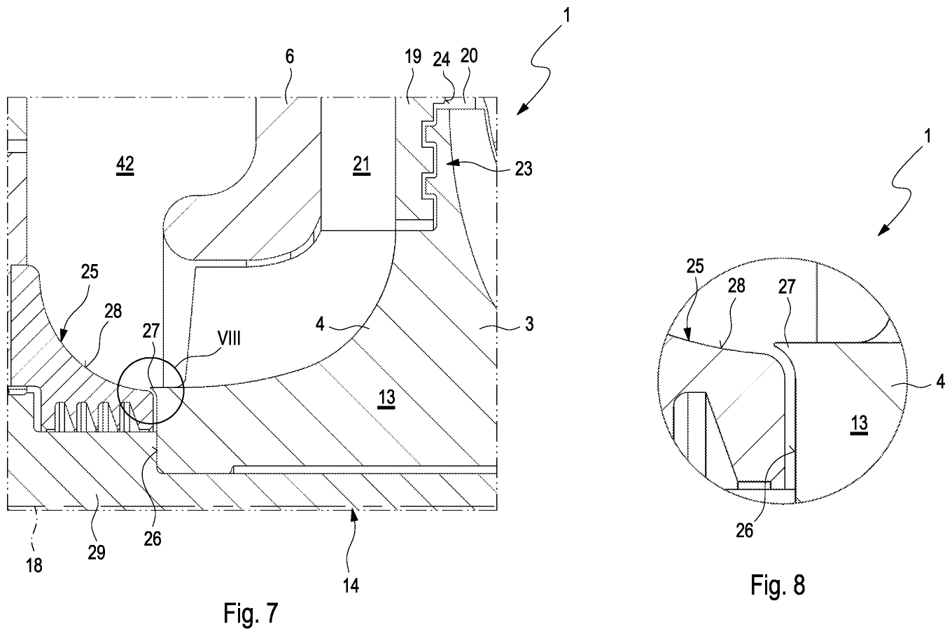

The reduction or preferably the prevention of lubricant transfer from the motor housing 7 into the expansion section 6 can be assisted with the aid of further exemplified embodiments, wherein, in particular, a sixth exemplified embodiment, as shown in FIGS. 7 and 8, wherein FIG. 8 is a detailed drawing VIII taken from FIG. 7, is expedient in this respect, wherein a hub surface 26 of the system wheel 13 facing towards the further sealing means 25 is concavely curved relative to the further sealing means 25. In particular, the curvature in the form of one protruding partially over the further sealing means 25 in the axial direction is produced in the manner of a projection. That is to say in other words that the hub surface 26 has a projection 27 which is designed partially surrounding an outer surface 28 of the further sealing means 25. That is to say in other words that the system wheel 13 is liquid-repellent. Therefore, lubricant which is conveyed via the further sealing means 25 in the direction of the system wheel 13 is conveyed outwards with the aid of a centrifugal force of the system wheel 13 in the radial direction and is moved with the aid of the projection 27 in the direction of an outlet 42 of the expansion section 6. Likewise, liquid in the form of water present in the expansion section 6 can be conveyed into the outlet 42, thus reducing the risk of ingress of the water into the motor housing 7.

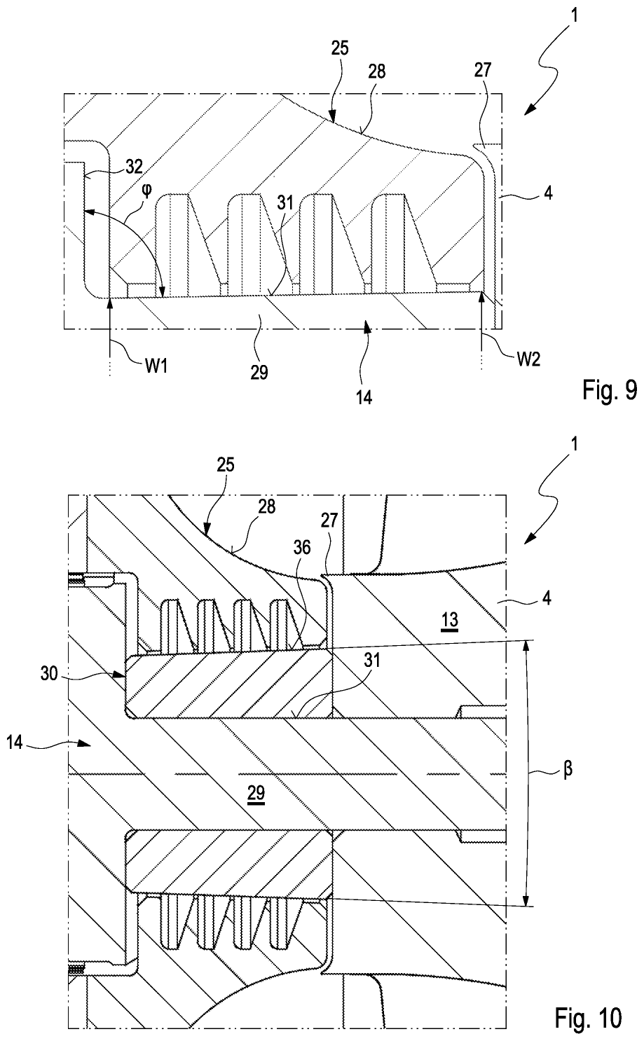

Further exemplified embodiments assisting the reduction or prevention of lubricant transfer are illustrated in FIGS. 9 and 10, wherein the exemplified embodiments can obviously be configured additively and not necessarily separately. In FIG. 9 which shows a longitudinal sectional detail of the inventive charging system 1 in a seventh exemplified embodiment, an intermediate shaft section 29 which has the further sealing means 25 is produced in the form of a truncated cone, wherein a first shaft diameter W1 closest to the motor housing 7 is smaller than a second shaft diameter W2 facing towards the expansion wheel 4. Therefore, between a section periphery 31 of the intermediate shaft section 29 and a section wall 32 perpendicular to the longitudinal axis 18 there is formed an angle φ which has a value of less than 90°. That is to say in other words that the shaft diameter increases in the direction of the longitudinal axis 18 starting from the motor housing 7 in the direction of the expansion section 6. This can be continuous but can also be discontinuous.

FIG. 10 illustrates a longitudinal sectional detail of the inventive charging system 1 in an eighth exemplified embodiment, wherein a sleeve 30 is configured surrounding the intermediate shaft section 29 and is produced in the form of a hollow truncated cone. This has the advantage that cost-effective production of the shaft 14 is achieved. In the longitudinal sectional view shown in FIG. 10 a sleeve periphery 36 has an opening angle β in the direction of the system wheel 13, of which the value is greater than 0°.

With the aid of the conical design of the shaft 14 and/or the sleeve 30 and/or the correspondingly designed hub surface 26, concavely and/or with projection 27, in particular the projection 27 attached to a largest surface diameter of the hub surface 26, it is possible to convey liquids accumulated in the further seal into the outlet 42 of the expansion section 6.

The charging system 1 according to the first exemplified embodiment has the shaft 14 mounted on plain bearings. That is to say in other words that the shaft sections 15, 17 are rotatably mounted with the aid of a respective radial bearing 33 in the form of a plain bearing, and the first shaft section 15 facing away from the system wheel 13 is also rotatably mounted with the aid of an axial bearing 34 in the form of a plain bearing.

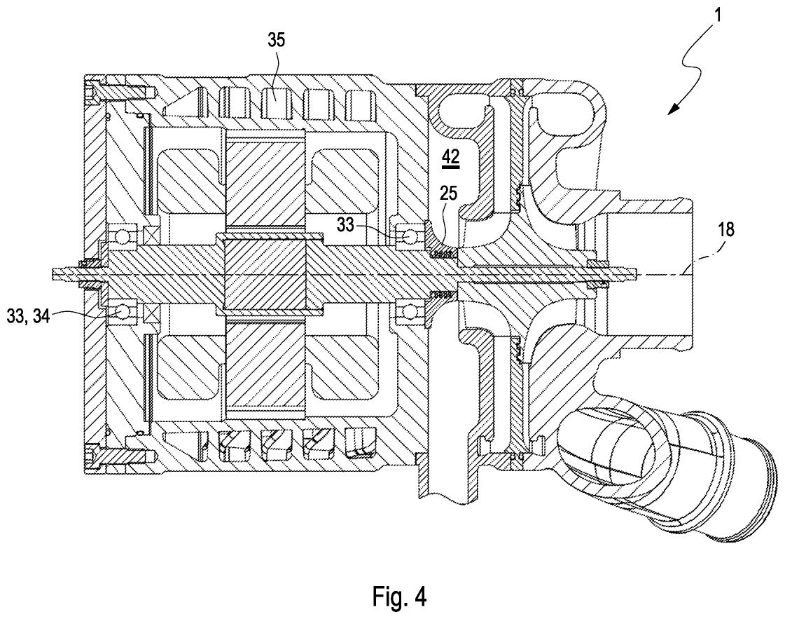

The charging system 1 illustrated as shown in FIG. 4 in a third exemplified embodiment corresponds substantially to the charging system 1 of the first exemplified embodiment, wherein, however, the two radial bearings 33 and the axial bearing 34 are produced in the form of a rolling bearing, wherein the functions of the radial bearing 33 and of the axial bearing 34 of the first shaft section 15 are combined in a rolling bearing. A further difference between the inventive charging system 1 of the second exemplified embodiment and the inventive charging system 1 of the first exemplified embodiment can be seen in the motor housing 7 which is designed having a cooling jacket 35 for water cooling. In order to reduce or prevent an ingress of hydrogen, in particular non-“combusted” hydrogen of exhaust gas of the fuel cell, into the rolling bearing located close to the expansion section 6 and in the form of the radial bearing, the further sealing means 25 is designed covering the radial bearing 33 in its radial extension. Described in other words, the radial extent of the further sealing means 25 is greater than that of the radial bearing 33 in the form of the rolling bearing.

In a further exemplified embodiment of the inventive charging system 1 which is not illustrated in greater detail, the motor housing 7 and a second expansion section part 41 of the expansion section 6, which is arranged between the first expansion section part 38 and the motor housing 7, is formed as a single piece with the motor housing 7. The advantage can be seen in a reduction of sealing means 22 which naturally are to be arranged between the motor housing 7 and the second expansion section part 41, in order to effect sealing-tightness.

In a further exemplified embodiment, not illustrated in greater detail, the shaft 14 has a roller bearing which could, of course, be replaced by a plain bearing. The expansion section 6 is formed as a single piece with the motor housing 7 which has a cooling jacket 35. Furthermore, the housing wall 19 is likewise produced as a single piece with the expansion section 6. In order to securely position the further sealing means 25, it is connected to the motor housing 7 in a force-fitting and form-fitting manner preferably by means of a screw connection. Formed at the end of the motor housing 7 facing away from the system wheel 13 is an inverter which accommodates circuit boards. The cooling jacket 35 is designed for water cooling.

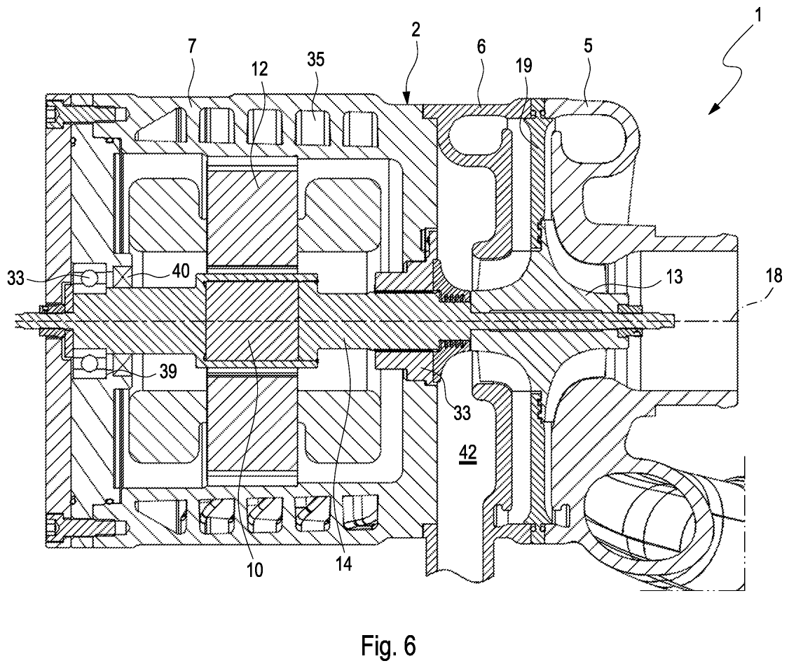

FIG. 6 illustrates a longitudinal sectional view of the inventive charging system 1 in a fifth exemplified embodiment, wherein this charging system 1 is characterised by a combination of different types of bearing. Therefore, by way of example the radial bearing 33 arranged facing towards the system wheel 13 is designed in the form of an air bearing and the radial bearing 33 arranged facing away from the system wheel 13 is designed in the form of a rolling bearing. Likewise, all bearings 33, 34 can be designed in the form of an air bearing and/or rolling bearing and/or plain bearing. A combination is possible. It should be noted that in order to prevent ingress of hydrogen, in particular exhaust gas of the fuel cell which can have non-combusted hydrogen, into the bearing 33; 34, which is designed in the form of a rolling bearing, an additional sealing means 40 is to be arranged at a side 39 of the bearing 33; 34 arranged facing towards the system wheel 13. The cooling jacket 35 is designed for water cooling.

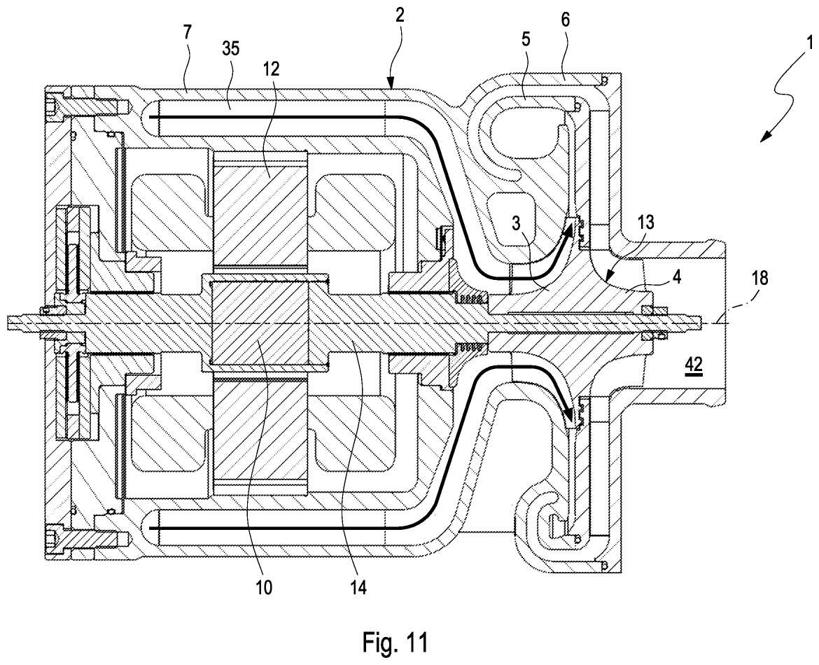

FIG. 11 illustrates the charging system 1 in accordance with the invention in a ninth exemplified embodiment. The system wheel 13 has the compression wheel 3 arranged facing towards the motor housing 7 and has the expansion wheel 4 arranged facing away from the motor housing 7. Therefore, the compression wheel 3 can draw in air from the environment via the cooling jacket 35 of the motor housing 7, whereby the electric motor 8 can be cooled.

In a further exemplified embodiment which is not illustrated in greater detail, the expansion channel 21 upstream of the expansion wheel 4 is equipped with a flow cross-section-changing device so that a flow cross-section formed upstream of the expansion wheel 4 can be varied. The flow cross-section-changing device can be designed e.g. in the form of an axial slide valve or in the form of rotatable guide vanes according to a known adjustable turbine geometry.

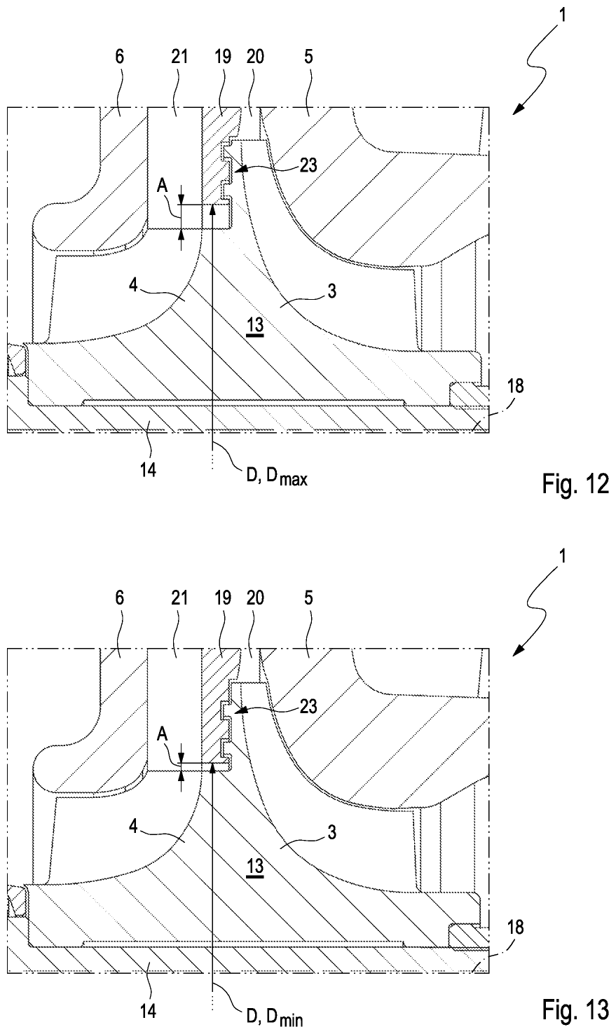

In a further exemplified embodiment of the charging system 1 in accordance with the invention, a tenth exemplified embodiment according to FIG. 12 and an eleventh exemplified embodiment according to FIG. 13, so-called trimming of the system wheel 13 is provided in order to adapt a power of the charging system 1, said trimming can be achieved with the aid of the housing wall 19, wherein, between the expansion wheel 4, which has preferably a smaller diameter than the compression wheel 3, and the housing wall 19 a distance A is to be provided in a variable manner, by changing an inner housing wall diameter D. In so doing, diameter limit values, a smallest inner housing wall diameter Dₘᵢₙ and a largest inner housing wall diameter Dₘₐₓ are to be taken into account. With the aid of the inner housing diameter D, it is possible to effect adjustment of a shear force which acts upon the two wheels, the expansion wheel 4 and the compression wheel 3.

In a further exemplified embodiment which is not illustrated in further detail, a pretensioning system is formed which is provided in order to axially pretension the rolling bearing arrangement, for receiving axial loads.

If the bearings are designed in the form of rolling bearings, they can have additional damping elements, e.g. in the form of a metallic elastic structure or in the form of a synthetic material which has damping properties and is arranged around the rolling bearing.

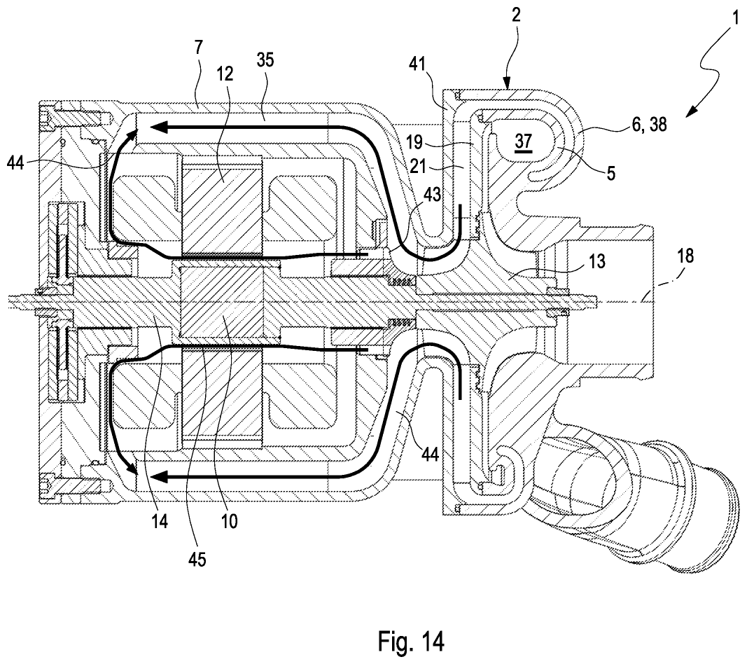

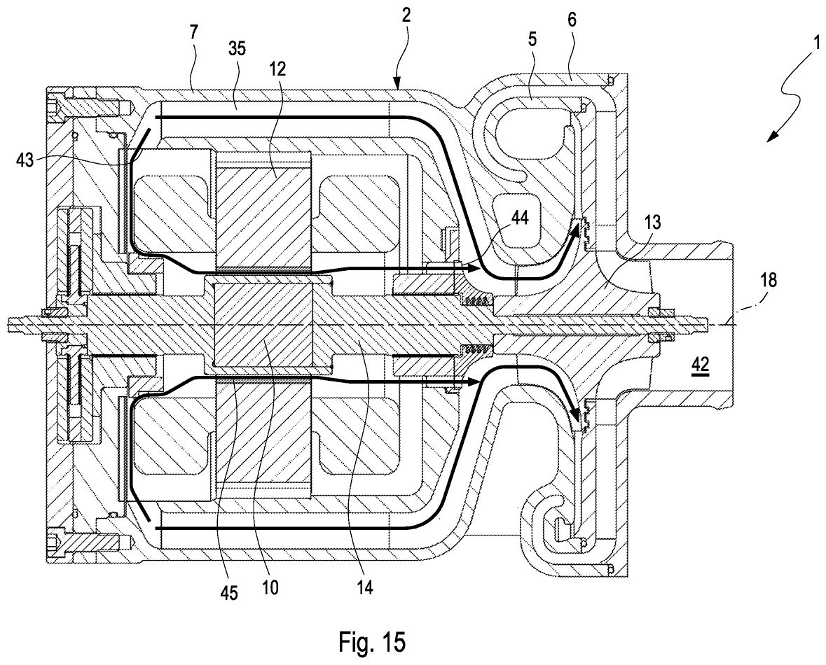

FIGS. 14 and 15 illustrate the inventive charging system 1 of a fuel cell in a twelfth and a thirteenth exemplified embodiment respectively. The charging system 1 of the twelfth exemplified embodiment as illustrated according to FIG. 14 corresponds to the greatest possible extent to the charging system 1 of the fourth exemplified embodiment, see FIG. 5, wherein, however, the motor housing 7 has a first housing opening 43 and a second housing opening 44 so that, in order to cool the stator 12 and the rotor 10, the expansion gas can flow from the first housing opening 43 into the second housing opening 44 via an air gap 45 formed between the rotor 10 and the stator 12. Therefore, additional cooling of the electric motor 8 is provided.

The charging system 1 of the thirteenth exemplified embodiment which is configured according to FIG. 15 corresponds to the greatest possible extent to the ninth exemplified embodiment of the charging system 1 in accordance with the invention which is illustrated in FIG. 11. The fresh air provided for additional cooling of the electric motor 8 flows from the first housing opening 43 into the second housing opening 44 via the air gap 45 and is supplied to the expansion section 6. In this case, the first housing opening 43 is provided in the region of an end of the housing 7 arranged facing away from the system wheel 13.

Preferably, in both cases for the purpose of directed flow through the air gap 45, the first housing opening 43 of the twelfth exemplified embodiment or the second housing opening 44 of the thirteenth exemplified embodiment is arranged at the level of the air gap 45, or in other words at a radial distance from the longitudinal axis 18, which corresponds to a radial distance of the air gap 45 from the longitudinal axis 18.

In a further exemplified embodiment which is not illustrated in greater detail, the compression section 5 has an adjustable guide geometry. The guide geometry can be formed from an adjustable guide vane arrangement upstream of the compression wheel 3 and/or an adjustable nozzle vane arrangement downstream of the compression wheel 3 around the compression section 5. Likewise, in the case of a combination of the vane arrangements one of the two vane arrangements can be rigid.

With the aid of the adjustable guide vane arrangement in the form of a guide vane—pivotable about an axis—of the guide vane arrangement upstream of the compression wheel 3, an entrance angle of an air mass flow can be optimised for different rotational speeds. If the adjustable guide vane arrangement is designed in the form of an aperture, similar to an optical aperture, a mass flow can be easily adapted. If the adjustable nozzle vane arrangement is designed in the form of turnable guide vanes, an air mass flow exit angle exiting from the compression section 5 can be easily adapted.

The electric motor 8 can be designed differently. For instance, the stator 12 can be wound differently. For example, the winding can have grooves or no grooves and/or can have concentrated windings or distributed windings.

In a further exemplified embodiment which is not illustrated in greater detail, one of the wheels 3; 4, the compression wheel 3 or the expansion wheel 4, for receiving the shaft 14, can have an opening with an internal thread, or the shaft 14 is pressed into the opening.

In a further exemplified embodiment which is not illustrated in greater detail, a measuring device is provided for measuring a speed and/or an acceleration and/or a temperature and/or a pressure etc., wherein sensors of the measuring device are arranged preferably on the side of the electric motor 8 facing away from the wheels 3, 4.

In a further exemplified embodiment which is not illustrated in greater detail, a further compression wheel is provided which is arranged on the side of the electric motor 8 facing away from the wheels 3, 4.

### LIST OF REFERENCE SIGNS

1 charging system
2 housing
3 compression wheel
4 expansion wheel
5 compression section
6 expansion section
7 motor housing
8 electric motor
9 compression wheel shaft
10 rotor
11 expansion wheel shaft
12 stator
13 system wheel
14 shaft
15 first shaft section
16 end section
17 second shaft section
18 longitudinal axis
19 housing wall
20 compression channel
21 expansion channel
22 sealing means
23 seal
24 wall surface
25 further sealing means
26 hub surface
27 projection
28 outer surface
29 intermediate shaft section
30 sleeve
31 section periphery
32 section wall
33 radial bearing
34 axial bearing
35 cooling jacket
36 sleeve periphery
37 spiral
38 first expansion section part
39 side
40 additional sealing means
41 second expansion section part
42 outlet
43 first housing opening
44 second housing opening
45 air gap
A distance
D inner housing wall diameter
D_{min.} smallest inner housing wall diameter
D_{max.} largest inner housing wall diameter
TE expansion gas temperature
TK compression gas temperature
W1 first shaft diameter
W2 second shaft diameter
φ angle
β opening angle

1.-17. (canceled)

18. A charging system (1) of a fuel cell, comprising
a housing (2) for receiving a rotatable compression wheel (3) and a rotatable expansion wheel (4),
wherein the housing (2) comprises a compression section (5) and an expansion section (6),
wherein the compression section (5) is designed to receive the compression wheel (3) and the expansion section (6) is designed to receive the expansion wheel (4),
wherein the compression section (5) and the expansion section (6) are designed to effect wall heat exchange of compression gases flowing in the compression section (5) and expansion gases flowing in the expansion section (6),
wherein the compression wheel (3) and the expansion wheel (4) are a single-piece system wheel (13) which has a shaft (14),
wherein a housing wall (19) separating the compression section (5) and the expansion section (6) has a labyrinth seal (23),
wherein the labyrinth seal is formed between the compression wheel (3) and the housing wall (19),
wherein the expansion wheel (4) has a smaller diameter than the compression wheel (3),
wherein the system wheel (13) is liquid-repellent, and
wherein a hub surface (26) of the system wheel (13) facing an electric motor (8) has a projection (27).

19. The charging system (1) as claimed in claim 18,
wherein the expansion section (6) is designed at least partially surrounding the compression section (5).

20. The charging system (1) as claimed in claim 18,
wherein the compression wheel (3) is produced from a first material and the expansion wheel (4) is produced from a second material which corresponds to the first material.

21. The charging system (1) as claimed in claim 18,
wherein the expansion section (6) is arranged at least partially axially next to the compression section (5), and
wherein the compression section (5) and the expansion section (6) have a common housing wall (19).

22. The charging system (1) as claimed in claim 18,
wherein the shaft (14) can be driven by the electric motor (8).

23. The charging system (1) as claimed in claim 22,
wherein the electric motor (8) is surrounded by a motor housing (7) which is designed to mount the shaft (14).

24. The charging system (1) as claimed in claim 23,
wherein the motor housing (7) is designed at least partially as a single piece with the housing (2).

25. The charging system (1) as claimed in claim 22,
wherein the shaft (14) is a built-up shaft.

26. The charging system (1) as claimed in claim 25,
wherein the shaft (14) is designed to receive a rotor (10) of the electric motor (8).

27. The charging system (1) as claimed in claim 18,
wherein the shaft (14) has a radial bearing (33) which is a plain bearing or a rolling bearing or an air bearing.

28. The charging system (1) as claimed in claim 18,
wherein the shaft (14) has an axial bearing (34) which is a plain bearing or a rolling bearing or an air bearing.

29. The charging system (1) as claimed in claim 18,
wherein a further sealing means (25) is arranged on a conical section of the shaft (14) and/or on a conical sleeve (30) surrounding the shaft (14).

30. The charging system as claimed in claim 29,
wherein the further sealing means (25) is a further labyrinth seal.

31. The charging system (1) as claimed in claim 18,
wherein the system wheel (13) is liquid-resistant.

32. The charging system (1) as claimed in claim 18,
wherein a flow cross-section-changing device is formed upstream of the expansion wheel (4) in the expansion section (6).
